(19) United States
(12) Patent Application Publication
(10) Pub. No.: US 2013/0145688 A1
(43) Pub. Date: Jun. 13, 2013

(54) METHOD FOR CULTIVATING PLANT AND PLANT CULTIVATION DEVICE

(71) Applicants: Naoyuki Tatsumi, Osaka-shi (JP); Hiroshi Fuji, Osaka-shi (JP); Fumiteru Akamatsu, Suita-shi (JP); Akio Kobayashi, Suita-shi (JP); Shuji Kurimoto, Suita-shi (JP); Yoshito Suda, Suita-shi (JP); Kazuhito Fujiyama, Suita-shi (JP); Atsushi Okazawa, Suita-shi (JP); Kazumasa Hirata, Suita-shi (JP); Kazuo Harada, Suita-shi (JP); Takashi Machimura, Suita-shi (JP); Satoru Kato, Suita-shi (JP); Jun Hayashi, Suita-shi (JP)

(72) Inventors: Naoyuki Tatsumi, Osaka-shi (JP); Hiroshi Fuji, Osaka-shi (JP); Fumiteru Akamatsu, Suita-shi (JP); Akio Kobayashi, Suita-shi (JP); Shuji Kurimoto, Suita-shi (JP); Yoshito Suda, Suita-shi (JP); Kazuhito Fujiyama, Suita-shi (JP); Atsushi Okazawa, Suita-shi (JP); Kazumasa Hirata, Suita-shi (JP); Kazuo Harada, Suita-shi (JP); Takashi Machimura, Suita-shi (JP); Satoru Kato, Suita-shi (JP); Jun Hayashi, Suita-shi (JP)

(73) Assignees: OSAKA UNIVERSITY, Suita-shi, Osaka (JP); SHARP KABUSHIKI KAISHA, Osaka-shi, Osaka (JP)

(21) Appl. No.: 13/701,416

(22) PCT Filed: Apr. 19, 2011
(86) PCT No.: PCT/JP2011/059649

§ 371 Date: Jan. 29, 2013

(30) Foreign Application Priority Data
Jun. 4, 2010 (JP) 2010-128958

(51) Int. Cl. A01G 9/00; A01G 1/00

(52) U.S. Cl. CPC A01G 9/00; A01G 1/001
USPC 47/60; 47/58.1 R

(57) ABSTRACT

A plant cultivation method of the present invention includes the steps of: placing a plant under a condition at a pressure of not less than 1.5 atmospheres and not more than 10 atmospheres; and cultivating the plant. A plant cultivation device (1) includes: a cultivation chamber (10); and a compressor (20) which supplies compressed air into the cultivation chamber. A carry-in opening (30), which is provided on a side wall (16) of the cultivation chamber (10) so that a material is carried in/out to/from the cultivation chamber (10) via the carry-in opening (30), is provided with a cover (31) which has a shape that is hemispherical and protrudes toward an inside of the cultivation chamber (10). The cover (31) closes the carry-in opening (30) by being in contact, via a packing (32), with an inner surface of the side wall (16) surrounding the carry-in opening (30). The cultivation chamber (10) has an internal pressure higher than an atmospheric pressure by causing the compressor (20) to supply compressed air into the cultivation chamber (10) in a state in which the carry-in opening (30) is closed. A plant growth rate is improved by cultivating a plant in a high pressure environment which is different from a natural environment. A plant cultivation device is provided for achieving plant cultivation in a high pressure environment.

### TECHNICAL FIELD

The present invention relates to a method for plant cultivation in a high pressure environment, and a plant cultivation device which is used to cultivate a plant in a high pressure environment.

### BACKGROUND ART

A food market, especially a fresh vegetable market has been growing in size, whereas problems have been growing evident. Examples of the problems include climate change, a decline in employed agricultural population, aging of farmers, a decrease in food self-sufficiency rate, disguise of production regions. This causes a matter of concern about food safety and security.

Such circumstances have been raising more expectations for a so-called plant factory so as to (i) supply chemical-free vegetables, (ii) improve traceability of products such as vegetables, (iii) achieve stable production and supply, and (iv) increase a food self-sufficiency rate. A plant factory refers to a facility for cultivating a plant in an enclosed and environmentally-controlled space. Japan is currently making efforts at a widespread use of plant factories as its national policy in view of, for example, an increase in food self-sufficiency rate, safety, and an advanced use of land.

In order to develop a plant factory, it is significant to, for example, (i) control various parameters related to plant growth such as a light intensity and a temperature, (ii) create an optimum environment for plant growth, (iii) shorten a cultivation period, and (iv) increase an yield. For example, a research has been carried out concerning which wavelength of light, out of wavelengths of light to be emitted from a light source, contributes to plant growth.

FIG. 10 shows a relationship between a type of LED light, or a ratio between red LED (R) light and blue (B) LED light, and a plant growth rate. FIG. 10 is data posted on a web site of Plant Factory Laboratory (refer to Nonpatent Literature 1). Referring to a result shown in this drawing, it is possible to create a lighting environment suitable for plant growth.

Patent Literature 1 discloses a minute pressure control device for controlling a pressure in an enclosed space for plant cultivation or the like to be slightly different from an outdoor air pressure. FIG. 11 shows an arrangement of a stationary pressure control device which is disclosed in Patent Literature 1.

The pressure control device shown in FIG. 11 includes an air buffer 101 which is provided on a floor surface 132 of an airtight container 102. The air buffer 101 is made of an elastic material such as rubber and has a hollow rectangular shape. A duct 109 is connected to the air buffer 101, and the duct 109 communicates, via a valve 103, with a duct 107, which is connected to a closed module (not illustrated) to be controlled.

A duct 111 is connected to the duct 109 and exposed to atmospheric air via a valve 104. Meanwhile, the airtight container 102 is provided with a duct 112 which is exposed to atmospheric air via a valve 106, and a duct 110 which is connected to the duct 107 via a duct 105.

The pressure control device shown in FIG. 11 and having the arrangement is capable of controlling a pressure in the closed module to be minute and positive or negative with respect to an outdoor air pressure. For example, in order to control the pressure in the closed module to be positive, the pressure control device closes the valve 104 and the valve 105, whereas the pressure control device opens the valve 103 and the valve 106. Accordingly, since the valve 106 is open, atmospheric pressure is drawn into the airtight container 102 via the duct 112. In this case, an internal pressure of the air buffer 101 is equal to a pressure obtained by adding an internal pressure (atmospheric pressure) of the airtight container 102 and an empty weight of a film member of the air buffer 101. This causes the pressure in the closed module to be minute and positive with respect to the atmospheric pressure. Since the valve 103 is open, an inside of the air buffer 101 communicates with the closed module via the duct 109. Therefore, the pressure in the closed module is controlled to be minute and positive as in the case of the internal pressure of the air buffer 101.

### CITATION LIST

### Patent Literature

Patent Literature 1

Japanese Patent Application Publication, Tokukaihei, No. 11-334789 (Publication Date: Dec. 7, 1999)

### Nonpatent Literature

Nonpatent Literature 1

“Handoutai kougen ni yoru seichou-ritsu (Growth rate measured by use of semiconductor light source)”, online, Search Date: May 12, 2010, URL <http://www.sasrc.jp/seicho.htm>

### SUMMARY OF INVENTION

### Technical Problem

Artificial lighting using an LED and a minute pressure control using a pressure control device serve as examples of a natural environment imitated in a facility. Namely, a conventional plant factory intends to cause an environment in a facility to resemble a natural environment as much as possible.

On the contrary, hardly any attempt has been made to cultivate a plant in an environment which is significantly different from a natural environment. In particular, no knowledge has been acquired about a growth state in a high pressure environment which is impossible in a natural environment.

In view of the circumstances, an object of the present invention is to (i) improve a plant growth rate by cultivating a plant in a high pressure environment which is different from a natural environment and (ii) provide a plant cultivation device for achieving plant cultivation in such a high pressure environment.

### Solution to Problem

In order to attain the object, a plant cultivation method in accordance with the present invention includes the steps of: placing a plant under a condition at a pressure of not less than 1.5 atmospheres and not more than 10 atmospheres; and cultivating the plant.

The method enables further promotion of plant growth as compared to a method of cultivating a plant at a normal pressure (approximately 1 atmosphere).

In order to attain the object, a plant cultivation device in accordance with the present invention includes: a cultivation chamber in which plant cultivation is carried out; a compressor which supplies compressed air into the cultivation chamber; a carry-in opening which is provided on a wall of the cultivation chamber and via which a material is carried in/out to/from the cultivation chamber; and a cover which is provided to the carry-in opening and has a shape that protrudes toward an inside of the cultivation chamber, the cover closing the carry-in opening by being in contact with a surface of the wall surrounding the carry-in opening, the surface being located on the cultivation chamber side, and the cultivation chamber having an internal pressure higher than an atmospheric pressure by causing the compressor to supply compressed air into the cultivation chamber in a state in which the carry-in opening is closed.

A plant cultivation device of the present invention includes a cultivation chamber and a compressor which supplies compressed air into the cultivation chamber. The plant cultivation device causes the cultivation chamber to have an internal pressure higher than an atmospheric pressure by causing the compressor to supply compressed air in a state in which a carry-in opening provided to the cultivation chamber is closed with a cover.

According to such a plant cultivation device, the cover provided to the carry-in opening closes the carry-in opening by being in contact with a surface (i.e., an inner surface) of a wall surrounding the carry-in opening, the surface being located on the cultivation chamber side. In other words, the cover is arranged to cover the carry-in opening from the inside of the cultivation chamber.

Note here that, in a case where the internal pressure of the cultivation chamber is increased by supplying compressed air into the cultivation chamber from the compressor, an internal and external pressure difference causes a force toward an outside of the cultivation chamber to be applied to the cover. According to the arrangement in which the cover covers the side wall surrounding the carry-in opening from the inside of the cultivation chamber, the force is applied to the cover in a direction in which the cover is adhered to a side wall of the cultivation chamber. Thus, the arrangement enables an improvement in sealing property of the cultivation chamber. Further, the arrangement prevents the cover from coming off also in a case where the internal pressure of the cultivation chamber rises. This allows a vicinity of the carry-in opening to be more resistant to pressure.

In addition, the cover which has a shape that protrudes toward the inside of the cultivation chamber allows an increase in surface area of the cover. According to this, a large force which is caused by the internal pressure of the cultivation chamber is applied, toward the outside of the cultivation chamber, to a surface of the cover which surface faces the cultivation chamber. Thus, the arrangement allows a further improvement in sealing property in accordance with an increase in internal pressure of the cultivation chamber.

As described earlier, the plant cultivation device of the present invention makes it possible to cultivate a plant while maintaining an internal pressure of the cultivation chamber so that the internal pressure is higher than an atmospheric pressure.

In order to attain the object, the plant cultivation method in accordance with the present invention is a method for carrying out plant cultivation in a cultivation chamber for plant cultivation, the cultivation chamber being a sealed space in which a plant is placed, the method including the step of: cultivating the plant by causing a pressure device to increase an internal pressure of the cultivation chamber so that the internal pressure is higher than an atmospheric pressure.

The method allows further promotion of plant growth as compared to a plant cultivation method carried out at an atmospheric pressure (approximately 1 atmosphere).

### Advantageous Effects of Invention

A plant cultivation method in accordance with the present invention includes the steps of: placing a plant under a condition at a pressure of not less than 1.5 atmospheres and not more than 10 atmospheres; and cultivating the plant. The method enables further promotion of plant growth as compared to a method of cultivating a plant at a normal pressure (approximately 1 atmosphere).

A plant cultivation device in accordance with the present invention includes: a cultivation chamber in which plant cultivation is carried out; a compressor which supplies compressed air into the cultivation chamber; a carry-in opening which is provided on a wall of the cultivation chamber and via which a material is carried in/out to/from the cultivation chamber; and a cover which is provided to the carry-in opening and has a shape that protrudes toward an inside of the cultivation chamber, the cover closing the carry-in opening by being in contact with a surface of the wall surrounding the carry-in opening, the surface being located on the cultivation chamber side, and the cultivation chamber having an internal pressure higher than an atmospheric pressure by causing the compressor to supply compressed air into the cultivation chamber in a state in which the carry-in opening is closed.

The plant cultivation method in accordance with the present invention is a method for carrying out plant cultivation in a cultivation chamber for plant cultivation, the cultivation chamber being a sealed space in which a plant is placed, the method including the step of: cultivating the plant by causing a pressure device to increase an internal pressure of the cultivation chamber so that the internal pressure is higher than an atmospheric pressure.

This makes it possible to yield an effect of cultivating a plant while maintaining an internal pressure of the cultivation chamber so that the internal pressure is higher than an atmospheric pressure.

### BRIEF DESCRIPTION OF DRAWINGS

FIG. 1 schematically shows an arrangement of a plant cultivation device in accordance with an embodiment of the present invention.

FIG. 2 is an exploded view schematically showing components of a sealed structure of a carry-in opening of the plant cultivation device shown in FIG. 1.

FIG. 3 schematically shows how to close the carry-in opening with a cover which is provided to a side wall of a cultivation chamber of the plant cultivation device shown in

FIG. 4 schematically shows an arrangement of a plant cultivation device used in an example of the present invention.

FIG. 5 shows an external appearance of the plant cultivation device used in the example of the present invention.

FIG. 6 shows a result of the example of the present invention.

FIG. 7 is a graph showing a result of the example of the present invention.

FIG. 8 schematically shows an arrangement of a plant cultivation device in accordance with a second embodiment of the present invention.

FIG. 9 schematically shows an arrangement of a cover provided to a carry-in opening of the plant cultivation device shown in FIG. 8.

FIG. 10 is a graph showing a relationship between a type of LED light or a ratio between LED lights of respective colors, and a plant growth rate.

FIG. 11 schematically shows an arrangement of a conventional pressure control device used for pressure control of a plant cultivation chamber.

### DESCRIPTION OF EMBODIMENTS

Inventors of the present invention conducted an experiment of cultivating a plant in a high pressure environment which is impossible in a natural environment. As a result, the inventors accomplished the present invention by finding that a plant growth rate is higher in a high pressure environment than in an environment at a normal atmospheric pressure.

The following embodiments specifically describe arrangement examples of a plant cultivation facility and preferable cultivation conditions. Note that, unless otherwise specified, sizes, materials, shapes, relative positions, and the like of components described in each of the following embodiments do not intend to limit the scope of the present invention but merely serve as examples for explanation.

### Embodiment 1

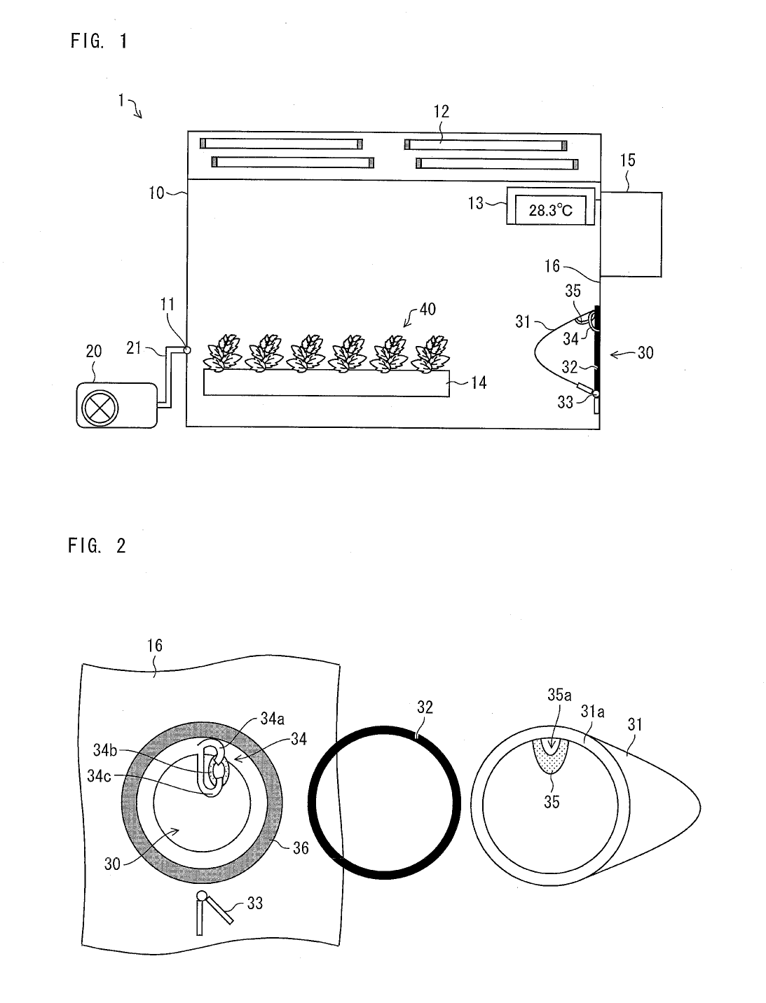

An embodiment of the present invention is described below with reference to FIG. 1 to FIG. 7.

First, the present embodiment discusses an arrangement of a plant cultivation device for achieving plant cultivation in a high pressure environment.

FIG. 1 shows an arrangement of a plant cultivation device 1 in accordance with an embodiment of the invention. The plant cultivation device 1 includes a cultivation chamber 10 of a closed system and an oil-free compressor 20 for causing an inside of the cultivation chamber 10 to be a high pressure environment (see FIG. 1).

An oil-free compressor 20 is connected, via a pipe 21, to an inlet/outlet 11 which is provided on a side wall 16 of the cultivation chamber 10. This makes it possible to supply compressed air to the cultivation chamber 10. A commonly used compressor can be used as the oil-free compressor 20, and a compressor to be used is not limited to an oil-free compressor.

The cultivation chamber 10 is large and wide enough for a man to enter an inside thereof for carrying out operation. The cultivation chamber 10 mainly includes a lighting apparatus 12 which is resistant to pressure, a temperature and humidity sensor 13, a nutrient solution supplying device 14, and a temperature and humidity control device 15.

The side wall 16 of the cultivation chamber 10 is provided with a carry-in opening 30 in addition to the inlet/outlet 11. A material is carried in/out from/to the cultivation chamber 10 via the carry-in opening 30. The carry-in opening 30 is closed by a sealed structure for creating a high pressure environment inside the cultivation chamber 10. A specific arrangement of the sealed structure is described later.

The cultivation chamber 10 is not provided with no opening to an outside for ventilation other than the carry-in opening 30 having the sealed structure and the inlet/outlet 11 connected to the oil-free compressor 20 (a compressor, a pressure device). Namely, a part of the cultivation chamber 10 which part is obtained by excluding the carry-in opening 30 and the inlet/outlet 11 is a completely sealed space.

The lighting apparatus 12 includes a light source which is resistant to a high pressure environment having a pressure of approximately not more than 10 atmospheres. The light source is exemplified by an LED (a light emitting diode), a fluorescent lamp, a metal halide lamp, and a high pressure sodium lamp. However, the light source is not particularly limited to these provided that the light source is resistant to a high pressure environment.

The temperature and humidity sensor 13 is connected to the temperature and humidity control device 15 which is provided outside or inside of the cultivation chamber 10. The temperature and humidity control device 15 is provided with an operation panel serving as a setting section for setting a temperature and a humidity of the cultivation chamber 10.

The temperature humidity control device 15 can be made by use of a general-purpose air conditioner which allows heat exchange in a state in which a space between the cultivation chamber 10 and an outside of the temperature humidity control device 15 is sealed. In accordance with information about the temperature and the humidity of the cultivation chamber 10, the information having been acquired by the temperature and humidity sensor 13, the temperature humidity control device 15 also maintains the temperature and the humidity of the cultivation chamber 10 which have been set.

Note that the operation panel may be replaced with a remote operation terminal such as a remote control or an information processing terminal (e.g., a personal computer). It is also possible to provide a humidifier in the cultivation chamber 10. It is preferable that the temperature and humidity control device 15 be resistant to a high pressure environment having a pressure of approximately not more than 10 atmospheres.

The nutrient solution supplying device 14 includes a tray in which plants 40 are provided and a culture solution tank which supplies water and a fertilizer to the tray. According to the nutrient solution supplying device 14, whose specific arrangement is not shown in the drawings, the tray in which the plants 40 are provided is supplied with a culture solution which has been pumped from the culture solution tank via an outward pipe, and the culture solution supplied to the tray returns to the culture solution tank via a return pipe. This enables nutriculture.

It is also possible to provide, for example, a water purifying apparatus which purifies water contained in a culture solution in the culture solution tank, and a fertilizer feeding apparatus which supplies a fertilizer or the like to a culture solution.

According to the plant cultivation device 1 of the present embodiment, it is possible to set, for example, a room temperature, a humidity, and an operating time by use of the operation panel such that in the daytime, the temperature is set to 25° C., the humidity is set to 60%, and the operating time is set to 16 hours, and in the nighttime, the temperature is set to 15° C., the humidity is set to 80%, and the operating time is set to 8 hours.

Note that the side wall 16 of the cultivation chamber 10 may be provided with an observation window via which a state of the inside of the cultivation chamber can be observed from the outside of the cultivation chamber. From the viewpoint of an improvement in pressure resistance and dew condensation prevention, it is preferable that the observation window be a double window.

In order to allow the observation window to be more resistant to pressure, it is more preferable that an inner part of the double window be made of pressure-resistant glass. Alternatively, in order to prevent dew condensation, it is also possible to provide an inner surface of the observation window (the cultivation chamber side surface of the observation window) with a water repellent sheet and/or a wiper.

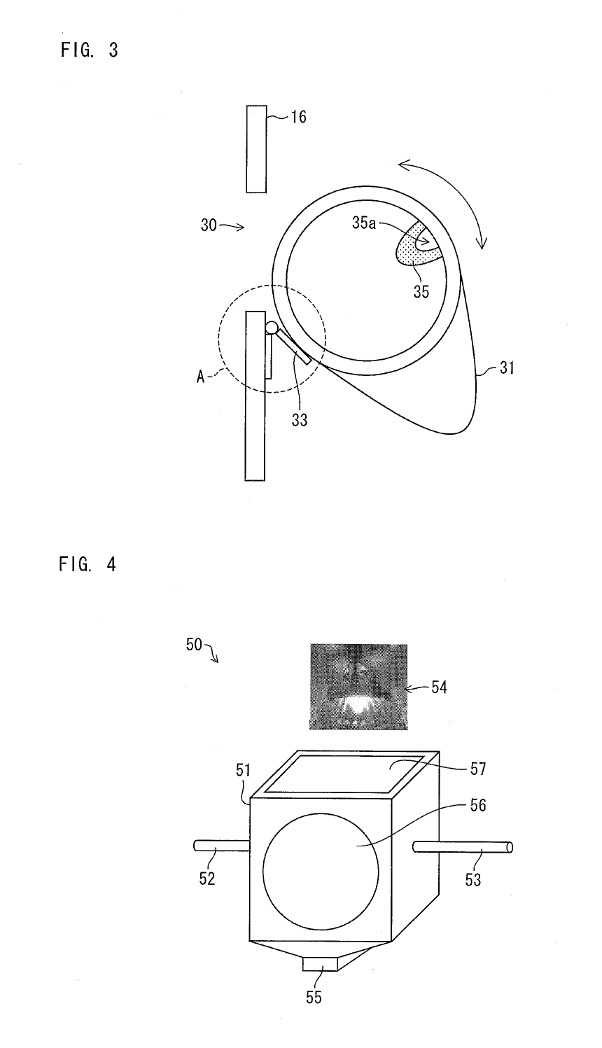

Subsequently, the sealed structure of the carry-in opening 30 is described below with reference to FIG. 1 to FIG. 3. FIG. 2 is an exploded view of components of the sealed structure provided to a surface of the wall surrounding the carry-in opening 30. FIG. 3 shows how to close the carry-in opening 30 with a cover 31 which is provided to the side wall of the cultivation chamber 10.

The components of the sealed structure include the cover 31, a packing (also referred to as a gasket) 32, a hinge 33, and a swivel 34 (see FIG. 1 and FIG. 3).

The cover 31, which is hemispherical, is provided to a surface of the wall surrounding the carry-in opening 30 so that a hemispherical protrusion is formed on an inner surface of the side wall 16 of the cultivation chamber 10 when the carry-in opening 30 is closed with the cover 31.

The packing 32 is embedded in a groove 36 formed on the inner surface of the side wall 16. When the carry-in opening 30 is closed with the cover 31, a surface 31a of the cover 31 is brought into contact with the groove, and then the packing 32 is sandwiched between the cover 31 and the side wall 16. This can prevent air from leaking out from a gap between the carry-in opening 30 and the cover 31.

The hinge 33 is provided to the inner surface of the side wall 16 in a lower part of the carry-in opening 30. Specifically, one side of the hinge 33 is connected to the inner surface of the side wall 16, and the other side of the hinge 33 is connected to an end of the cover 31 (see a circle A shown in FIG. 3 and drawn in a dashed line). The cover 31 is connected to the side wall 16 via the hinge 33, and the carry-in opening 30 is openable and closable by moving the cover 31 in a direction as shown by an arrow in FIG. 3.

The swivel 34 (a second connecting member) is provided to the inner surface of the side wall 16 in an upper part of the carry-in opening 30. The swivel 34 is constituted by a first protrusion 34a, a moving part 34b, and a second protrusion 34c. The moving part 34b is connected to the second protrusion 34c with a screw or the like, and is elastic. The moving part 34b is in contact with the first protrusion 34a in a normal state (in a state in which no external force is applied thereto). In a case where an external force is applied to the moving part 34b, the moving part 34b, which is elastic, is pressed toward the side wall 16 assuming that a point of connection with the second protrusion 34c is a reference point.

In order to cause the carry-in opening 30 to be in a closed state, it is possible to close the carry-in opening 30 with the cover 31 by embedding, in the swivel 34 which has a structure as described above, a protrusion 35 (first connecting member) which is U-shaped and is provided to an inner surface of the cover 31 which is hemispherical, into the is configured as above (i.e., by pressing the moving 34b of the swivel 34 with the protrusion 35 and causing the first protrusion 34a of the swivel 34 to be through the aperture 35a of the protrusion 35a). The inner surface of the cover 31 means an inner surface of a hemisphere. However, this inner surface, which faces the outside of the cultivation chamber, is also referred to as an outer surface.

According to the arrangement, the cover 31 can be fixed without fail with the carry-in opening 30 closed with the cover 31.

Note that a structure in which the swivel 34 and the protrusion 35 are connected is an example of the present invention and the present invention is not limited to the structure. It is only necessary to arrange the present invention such that the cover 31 can be fixed to the side wall 16 by causing the first connecting member provided to the cover 31 and the second connecting member provided to the side wall 16 in a vicinity of the carry-in opening 30 to engage with each other.

Note that the hinge 33 is provided to the side wall 16 in the lower part of the carry-in opening 30 and the swivel 34 is provided to the side wall 16 in the upper part of the carry-in opening 30 (see examples shown in FIG. 1 through FIG. 3). However, the present invention is not limited to such an arrangement. For example, the hinge 33 and the swivel 34 may be provided to the side wall 16 in the upper part and the lower part, respectively, of the side wall 16. Alternatively, the hinge 33 and the swivel 34 may be provided to either one of the right side or the left side of the carry-in opening. However, it is preferable that the hinge 33 and the swivel 34 be provided so as to face each other with the carry-in opening 30 therebetween. This enables the cover 31 to easily open and close the carry-in opening 30.

The plant cultivation device 1 having the arrangement is sealed, from the inside of the cultivation chamber 10 via the packing 32, with the cover 31 which is hemispherical. Therefore, in a case where an internal pressure of the cultivation chamber 10 is increased by supplying compressed air from the oil free compressor 20, an internal and external pressure difference causes a force toward an outside of the cultivation chamber to be applied to the cover 31 which is hemispherical.

This causes a force to be applied to the cover 31 in a direction in which the cover 31 is adhered to the side wall 16. This force increases in proportion to the increase in internal pressure. This allows an improvement in sealing property of the carry-in opening 30. The packing 32 provided between the cover 31 and the side wall 16 also allows an improvement in sealing property.

As described earlier, according to a structure of the plant cultivation device 1 of the present embodiment, an increase in external pressure (atmospheric pressure outside the cultivation chamber 10) prevents obtainment of an improvement in sealing property and pressure resistance, whereas the increase in internal pressure (atmospheric pressure inside the cultivation chamber 10) allows obtainment of a high sealing property and a high pressure resistance. The plant cultivation device 1 has a door which has a simpler structure than a door of a conventional sealed facility. Therefore, the door of the plant cultivation device 1 can be provided at a lower cost. The cultivation chamber 10 is provided with not only the carry-in entrance 30 having the sealed structure but also the inlet/outlet 11 which is connected to the oil-free compressor 20 and serves as an opening to the outside for ventilation. Meanwhile, a part of the cultivation chamber 10 which part is obtained by excluding the carry-in entrance 30 and the inlet/outlet 11 is a completely sealed space.

Therefore, the cultivation chamber 10 of the present embodiment can be used as a sealed facility which is resistant to a high pressure that is not more than approximately 10 atmospheres. This allows achievement of plant cultivation in a high pressure environment.

Note that according to the present embodiment, the cover 31 has a hemispherical shape. However, the present invention is not limited to this.

Each of the sealed structure and the cover of the present invention is required to have a structure which allows obtainment of a high sealing property and a high pressure resistance in case of the increase in internal pressure (pressure inside the cultivation chamber 10). In order to create such a structure, it is only necessary that the cover 31 which is closed (i) be in contact with the inner surface of the side wall 16 of the cultivation chamber 10 and (ii) have a shape protruding toward the inside of the cultivation chamber 10.

According to this, in case of the increase in internal pressure of the cultivation chamber 10, an internal and external pressure difference causes a force toward the outside of the cultivation chamber to be applied to the cover 31, so that a sealing property can improve. The cover 31 which has a shape protruding toward the inside of the cultivation chamber 10 allows a great force caused by the internal pressure of the cultivation 10 to be directed toward the outside of the cultivation chamber 10 on a surface of the cover 31.

Note that it is preferable that the cover 31 have a hemispherical shape from the viewpoint of obtainment of an effect of allowing a pressure to be applied equally to the surface of the cover 31.

The plant cultivation device 1 of the embodiment of the present invention assumes that plant cultivation is carried out in an environment whose pressure is much higher than an outdoor air pressure. Therefore, the plant cultivation device 1 is provided with no system for carrying out ventilation in the cultivation chamber 10. Therefore, in a case where ventilation needs to be carried out, ventilation is carried out in the cultivation chamber 10 by opening the carry-in opening 30 after stopping an application of a pressure by the oil compressor 20.

Subsequently, a plant cultivation method of the present invention is described below. The plant cultivation method of the present invention is a method for cultivating a plant by using, for example, the plant cultivation device 1 in high pressure environment which is impossible in a natural environment (e.g., has a pressure of not less than 2 atmospheres).

The inventors of the present invention cultivated a plant under a high pressure condition as shown in Example described later. Then, the inventors obtained a result such that plant growth was further promoted in a high pressure environment having a pressure of more than 1 atmosphere to 4 atmospheres than in an environment having a normal pressure (approximately 1 atmosphere).

Namely, according to the plant cultivation method of the present invention, plant growth is promoted by cultivating a plant in a high pressure environment having a pressure of not less than 1.5 atmospheres and not more than 10 atmospheres, preferably of not less than 1.5 atmospheres and not more than 4 atmospheres, and more preferably of not less than 2 atmospheres and not more than 3 atmospheres.

An example of the invention is described below.

### EXAMPLE

According to the present example, an influence of an atmospheric pressure on plant growth was examined under a condition in which a plant cultivation facility capable of changing its internal pressure was used and the internal pressure was variously changed.

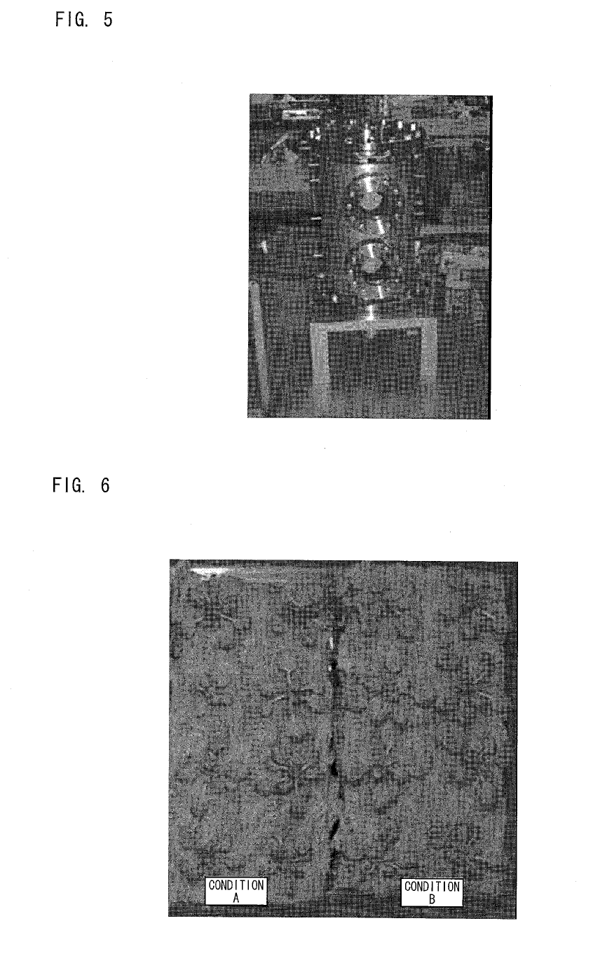

FIG. 4 shows an arrangement of a plant cultivation facility used in the present example. FIG. 5 shows an external appearance of the plant cultivation facility used in the present example.

A plant cultivation facility 50 mainly includes a pressure-resistant container 51, a gas supply pipe 52 which supplies compressed air to the pressure-resistant container 51, a gas exhaust pipe 53 which exhausts air from the pressure-resistant container 51, and a metal halide lamp 54 which emits light to an inside of the pressure-resistant container 51 (see FIG. 4).

The pressure-resistant container 51 is mainly provided with a culture solution storage 55 in which a culture solution for cultivating a plant is stored, an observation window 56 via which plant growth is observed from an outside, and a lighting window 57 via which light emitted from the metal halide lamp 54 is taken into the pressure-resistant container 51. The observation window 56 and the lighting window 57 are made of quartz glass.

According to the present example, two plant cultivation facilities 50 (see FIG. 4 and FIG. 5) were used, and a condition in which an internal pressure of one of the two plant cultivation facilities 50 was maintained at a normal pressure (this condition is referred to as a condition A), and a condition which was identical to the condition A except that an internal pressure of the other of the two plant cultivation facilities 50 was maintained at 2 atmospheres (this condition is referred to as a condition B).

Arabidopsis thaliana, which is designated as a standard plant in a cultivation and gene research field, was cultivated under each of the conditions A and B for two days.

Other conditions were a temperature of 13° C. to 18° C. and an illuminance of 80 μmol/m²·s (a bright period: 16 hours, a dark period: 8 hours). Rock wool was used as a culture medium (a base sheet shown in FIG. 6), a seedling of the Arabidopsis thaliana which seedling was obtained approximately 14 days after germination was planted in the rock wool. Then, the seedling was placed in a basin to be soaked in a commercially-available Hyponex aqueous solution (produced by HYPONeX JAPAN CORP., LTD.).

A result of this is shown in FIG. 6. As shown in FIG. 6, it was found that plant growth was further promoted under the condition B (shown on the right side of FIG. 6) than under the condition A (shown on the left side of FIG. 6). Specifically, an average leaf diameter of 1.25 cm was obtained under the condition A, whereas an average leaf diameter of 1.37 cm was obtained under the condition B. This reveals that plant growth was further promoted under the condition B than under the condition A by approximately 10%.

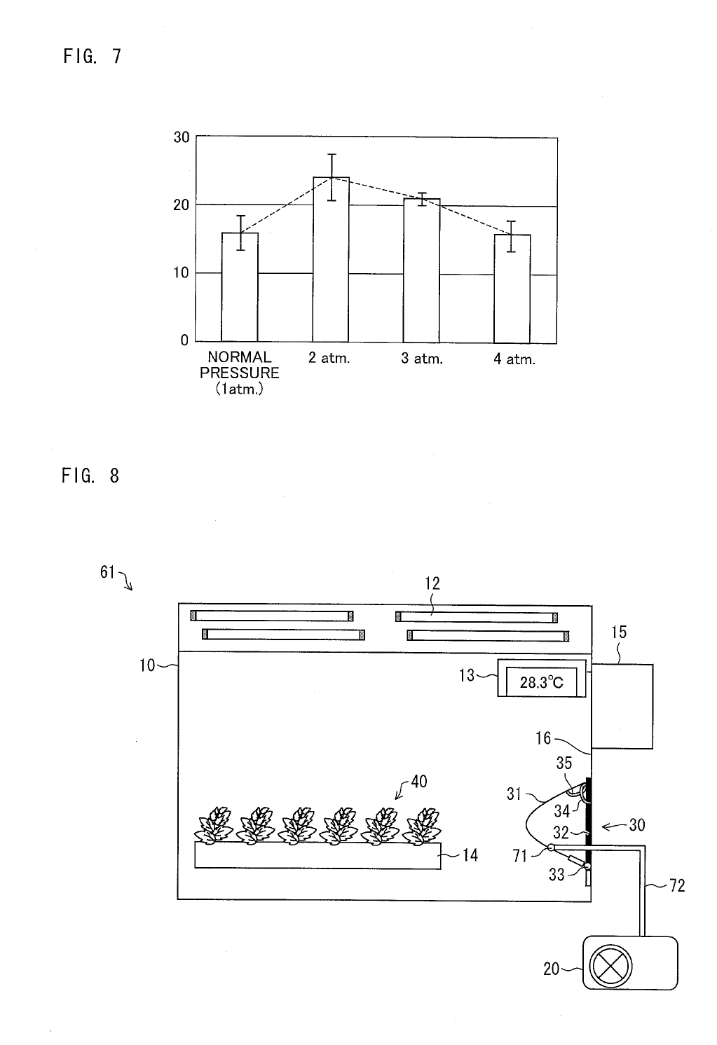

A graph of FIG. 7 shows the number (an average) of leaves of each seedling obtained in a case where Arabidopsis thaliana is grown under a condition which is identical to the condition A except that the internal pressure of the plant cultivation facility 50 was set to 1, 2, 3, and 4 atmospheres. As shown in the graph, it was found that the number of leaves was the highest at 2 atmospheres from 1 atmosphere to 4 atmospheres, the number decreased in accordance with an increase in atmospheric pressure, and leaves as many as those obtained at 1 atmosphere were obtained at 4 atmospheres.

Note that no experiment of plant cultivation is carried out between 1 atmosphere and 2 atmospheres, between 2 atmospheres and 3 atmospheres, and between 3 atmospheres and 4 atmospheres. However, it is expected that a result similar to that shown in a dashed line of FIG. 7 will be obtained.

According to the above results, it was confirmed that plant cultivation under a condition at an atmospheric pressure which was higher than a normal atmospheric pressure (approximately 1 atmosphere) (more preferably under a condition at an atmospheric pressure from 1.5 atmospheres to 4 atmospheres) allowed promotion of growth of a plant (especially a brassicaceous plant such as Arabidopsis thaliana).

As described earlier, according to the plant cultivation method of the present invention, a plant is cultivated in a high pressure environment having a pressure of not less than 1.5 atmospheres and not more than 10 atmospheres. Note here that it was determined in accordance with the graph shown in FIG. 7 that a lower limit value of 1.5 atmospheres was an atmospheric pressure that was more significantly capable of promoting plant growth than a normal pressure (1 atmosphere). Note also that it was determined that an upper limit value of 10 atmospheres was a physically settable atmospheric pressure in terms of a function of a plant cultivation device.

Note that according to the plant cultivation method of the present invention, it is more preferable to cultivate a plant in a high pressure environment having a pressure of not less than 1.5 atmospheres and not more than 4 atmospheres. According to this, it is possible to, for example, easily set a pressure condition by using the plant cultivation device of the present invention or the like. It is also possible to further promote plant growth under a condition at such a high pressure than under a condition at a normal atmospheric pressure (see FIG. 7).

It is more preferable to cultivate a plant in a high pressure environment having a pressure of not less than 2 atmospheres and not more than 3 atmospheres. According to this, the average number of leaves is not less than 20 in the present embodiment (see FIG. 7) and plant growth can be most promoted.

As described earlier, the plant cultivation method of the present invention allows further promotion of plant growth than a conventional plant cultivation method carried out at a normal pressure. As proved especially by the results of the present example, the plant cultivation method of the present invention enables a reduction in seedling raising period. Since the reduction in seedling raising period contributes to a cost reduction, the present invention seems to be high in usefulness. Therefore, it is preferable to apply the plant cultivation method of the present invention to seedling raising carried out in a seedling raising device or the like.

### Embodiment 2

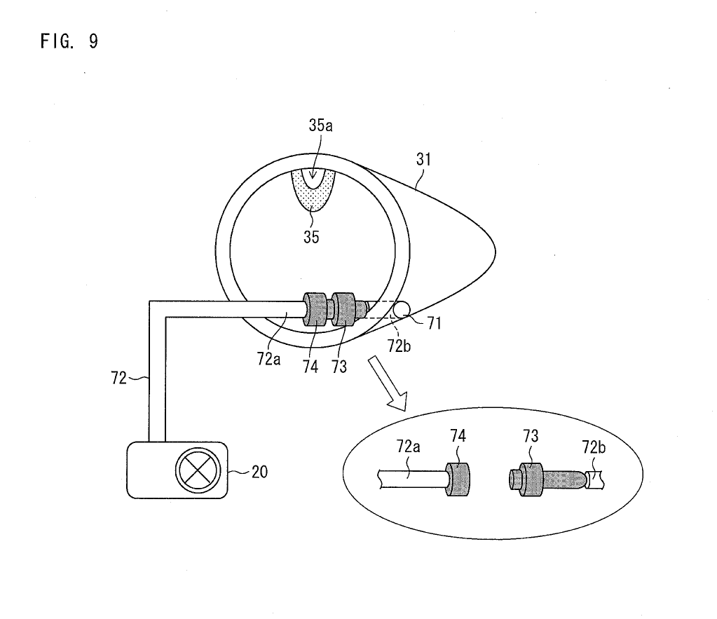

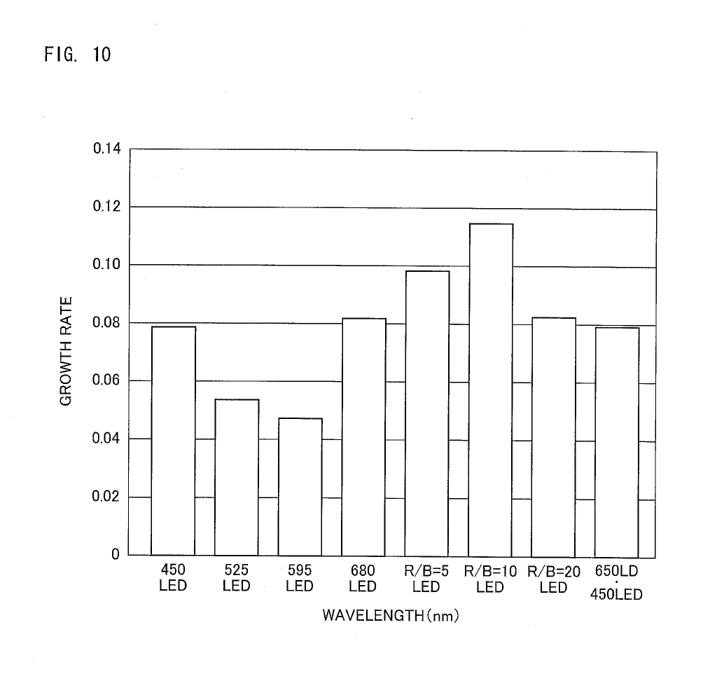

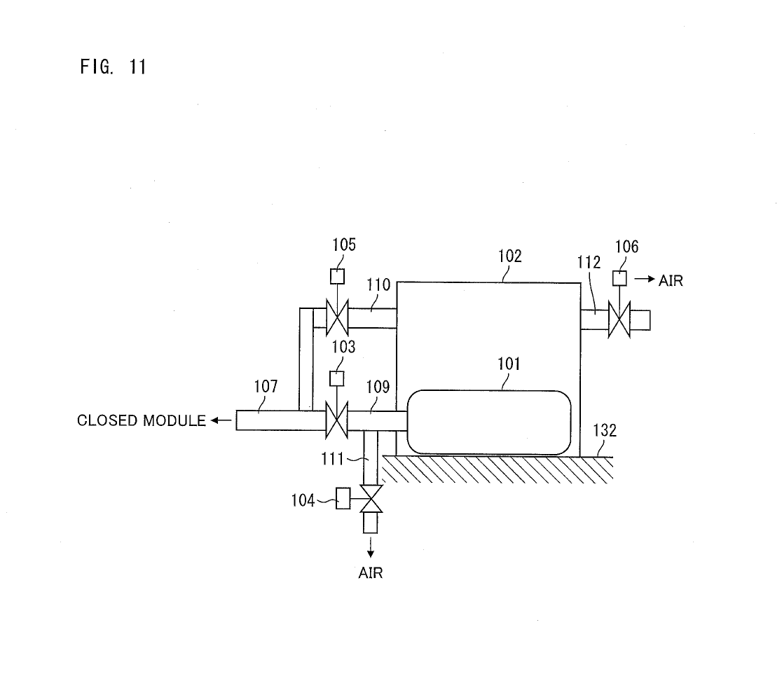

Next, a second embodiment of the present invention is described below with reference to FIG. 8 through FIG. 9. First, the present embodiment discusses another arrangement of a plant cultivation device for achieving plant cultivation in a high pressure environment.

FIG. 8 schematically shows an arrangement of a plant cultivation device 61 in accordance with the another embodiment of the present invention. The plant cultivation device 61 includes a cultivation chamber 10 of a closed system and an oil-free compressor 20 for causing an inside of the cultivation chamber 10 to be a high pressure environment (see FIG. 8). Note that members of the plant cultivation device 61 of the present embodiment, the members having arrangements identical to those of the respective members of the plant cultivation device 1 shown in FIG. 1 are given respective identical reference numerals.

The following description mainly discusses an arrangement which is different from that of Embodiment 1.

According to the present embodiment, the oil-free compressor 20 is connected, via a pipe 72, to an inlet/outlet 71 which is provided on a cover 31 for closing a carry-in opening 30. This makes it possible to supply compressed air to the cultivation chamber 10. A commonly used compressor can be used as the oil-free compressor 20.

As described above, the present embodiment is different from Embodiment 1 in that the inlet/outlet 71 is provided not on the side wall 16 of the cultivation chamber 10 but on a part of the cover 31. A description of the arrangements of the other members of the present embodiment, to which arrangements the respective arrangements of Embodiment 1 are applicable, is omitted here.

FIG. 9 shows an arrangement of (i) the cover 31 for closing the carry-in opening 30 and (ii) the oil-free compressor 20 which is connected to the inlet/outlet 71 provided on the cover 31. It is not particularly limited in which part of the cover 31 to provide the inlet/outlet 71. It is preferable that the inlet/outlet 71 be provided so as to be comparatively close to a hinge 33 (see FIG. 9).

According to this, in a case where the carry-in opening 30 is opened with the cover 31 open, the inlet/outlet 71 which is provided so as to be comparatively close to a hinge 33 can further prevent the pipe 72 from interfering with carrying in and out of a plant, a material, or the like as compared to the inlet/outlet 71 which is provided in a vicinity of a tip of the cover 31 which is hemispherical.

Note that the pipe 72 is obtained by connecting two pipes: a pipe 72b on the cover 31 side and a pipe 72a on the oil-free compressor 20 side. An English valve 73 is provided on the pipe 72b side, and a connecting part 74 which is connected with the English valve 73 is provided on the pipe 72a side.

According to the arrangement, even in a case where the oil-free compressor 20 once increased an internal pressure of the cultivation chamber 10 and then the English valve 73 and the connecting part 74 are disconnected by a function of the English valve 73, it is possible to maintain the internal pressure. Also in a case where a plant, a material, or the like is carried in and out with the carry-in opening 30 open, a disconnection of the pipe 72 (72a and 72b) in a space between the connecting part 74 and the English valve 73 makes it possible to prevent the pipe 72 from interfering with the carrying in and out.

The plant cultivation device 61 having the arrangement is sealed, from the inside of the cultivation chamber 10 via the packing 32, with the cover 31 which is hemispherical. Therefore, in a case where an internal pressure of the cultivation chamber 10 is increased by supplying compressed air from the oil-free compressor 20, an internal and external pressure difference causes a force toward an outside of the cultivation chamber to be applied to the cover 31 which is hemispherical. This causes a force to be applied to the cover 31 in a direction in which the cover 31 is adhered to the side wall 16. This force increases in proportion to the increase in internal pressure. This allows an improvement in sealing property of the carry-in opening 30. The packing 32 provided between the cover 31 and the side wall 16 also allows an improvement in sealing property.

As described earlier, according to a structure of the plant cultivation device 61 of the present embodiment, an increase in external pressure (atmospheric pressure outside the cultivation chamber 10) prevents obtainment of an improvement in sealing property and pressure resistance, whereas the increase in internal pressure (atmospheric pressure inside the cultivation chamber 10) allows obtainment of a high sealing property and a high pressure resistance.

Therefore, the cultivation chamber 10 of the present embodiment can be used as a sealed facility which is resistant to a high pressure that is not more than approximately 10 atmospheres. This allows achievement of plant cultivation in a high pressure environment.

According to the present embodiment, the inlet/outlet 71 is provided in the cover 31, and the cultivation 10 has no vent hole other than the carry-in opening 30. That is, it is possible to create a high pressure environment by providing, to a conventional closed facility, one (1) structure which can serve as both a carry-in opening and an inlet/outlet. Therefore, in a case where a conventional facility is renovated to obtain a plant cultivation device of the present invention, the arrangement of the present embodiment allows a further reduction in cost for the renovation as compared to the arrangement of Embodiment 1.

Note that the plant cultivation method of the present invention (described earlier) can be carried out by use of the plant cultivation device 61 of the present invention. It is only necessary that the cultivation chamber 10 be set to have an internal pressure of not less than 1.5 atmospheres and not more than 10 atmospheres, preferably of not less than 1.5 atmospheres and not more than 4 atmospheres, and more preferably of not less than 2 atmospheres and not more than 3 atmospheres. Plant cultivation in such a high pressure environment enables plant growth.

The present invention is not limited to the description of embodiments above, but may be altered by a skilled person within the scope of the claims. An embodiment based on a proper combination of technical means disclosed in different embodiments is encompassed in the technical scope of the present invention.

As described earlier, a plant cultivation method in accordance with the present invention includes the steps of: placing a plant under a condition at a pressure of not less than 1.5 atmospheres and not more than 10 atmospheres; and cultivating the plant.

The method enables further promotion of plant growth as compared to a method of cultivating a plant at a normal pressure (approximately 1 atmosphere).

The plant cultivation method of the present invention is preferably arranged such that the plant is placed under a condition at a pressure of not less than 1.5 atmospheres and not more than 4 atmospheres.

According to the method, it is possible to easily set up a pressure condition by using, for example, a plant cultivation device of the present invention. It is also possible to further promote plant growth under such a condition than under a condition at a normal atmospheric pressure (see FIG. 7).

In order to attain the object, a plant cultivation device in accordance with the present invention includes: a cultivation chamber in which plant cultivation is carried out; a compressor which supplies compressed air into the cultivation chamber; a carry-in opening which is provided on a wall of the cultivation chamber and via which a material is carried in/out to/from the cultivation chamber; and a cover which is provided to the carry-in opening and has a shape that protrudes toward an inside of the cultivation chamber, the cover closing the carry-in opening by being in contact with a surface of the wall surrounding the carry-in opening, the surface being located on the cultivation chamber side, and the cultivation chamber having an internal pressure higher than an atmospheric pressure by causing the compressor to supply compressed air into the cultivation chamber in a state in which the carry-in opening is closed.

A plant cultivation device of the present invention includes a cultivation chamber and a compressor which supplies compressed air into the cultivation chamber. The plant cultivation device causes the cultivation chamber to have an internal pressure higher than an atmospheric pressure by causing the compressor to supply compressed air in a state in which a carry-in opening provided to the cultivation chamber is closed with a cover.

According to such a plant cultivation device, the cover provided to the carry-in opening closes the carry-in opening by being in contact with a surface (i.e., an inner surface) of a wall surrounding the carry-in opening, the surface being located on the cultivation chamber side. In other words, the cover is arranged to cover the carry-in opening from the inside of the cultivation chamber. Note here that, in a case where the internal pressure of the cultivation chamber is increased by supplying compressed air into the cultivation chamber from the compressor, an internal and external pressure difference causes a force toward an outside of the cultivation chamber to be applied to the cover. According to the arrangement in which the cover covers the side wall surrounding the carry-in opening from the inside of the cultivation chamber, the force is applied to the cover in a direction in which the cover is adhered to a side wall of the cultivation chamber. Thus, the arrangement enables an improvement in sealing property of the cultivation chamber. Further, the arrangement prevents the cover from coming off also in a case where the internal pressure of the cultivation chamber rises. This allows a vicinity of the carry-in opening to be more resistant to pressure.

In addition, the cover which has a shape that protrudes toward the inside of the cultivation chamber allows an increase in surface area of the cover. According to this, a large force which is caused by the internal pressure of the cultivation chamber 10 is applied, toward the outside of the cultivation chamber, to a surface of the cover which surface faces the cultivation chamber. Thus, the arrangement allows a further improvement in sealing property in accordance with an increase in internal pressure of the cultivation chamber.

As described earlier, the plant cultivation device of the present invention makes it possible to cultivate a plant while maintaining an internal pressure of the cultivation chamber so that the internal pressure is higher than an atmospheric pressure.

Note that it is preferable that the cover have a protrusion having a curved surface. This prevents a pressure from being applied to the surface of the cover nonuniformly. Note here that the curved surface is exemplified by a hemispherical surface, a paraboloidal surface, a semielliptical surface, and a hyperboloidal surface.

The plant cultivation device of the present invention is preferably arranged such that the shape of the cover is hemispherical.

According to the arrangement, a pressure can be applied equally to the curved surface of the shape which is hemispherical.

The plant cultivation device of the present invention is preferably arranged to further include: a hinge which is provided to the surface of the wall of the cultivation chamber, the surface being located on the cultivation chamber side, the cover being connected via the hinge to the wall of the cultivation chamber.

The arrangement allows the cover to be constantly connected to the wall of the cultivation chamber. The arrangement also allows the carry-in opening to be opened and closed by moving the cover in accordance with a movement of the hinge.

The plant cultivation device of the present invention is preferably arranged to further include: a first connecting member which is provided on an outer surface of the cover; and a second connecting member which is provided on the wall of the cultivation chamber, the first connecting member and the second connecting member engaging with each other in a state in which the carry-in opening is closed with the cover.

Note here that the outer surface of the cover refers to a surface which is located outside the cultivation chamber in a state in which the carry-in opening is closed. According to the arrangement, it is possible to fix the cover in a state in which the carry-in opening is closed with the cover.

The plant cultivation device of the present invention is preferably arranged to further include: a packing which is provided between the cover and the wall of the cultivation chamber, the carry-in opening being closed in a state in which the packing is sandwiched between the cover and the wall surrounding the carry-in opening.

According to the arrangement, the packing which is sandwiched between the cover and the wall surrounding the carry-in opening allows securer prevention of a leak of air from a gap between the carry-in opening and the cover.

The plant cultivation device of the present invention is preferably arranged to further include: an inlet/outlet which is provided to the cover, the compressor supplying compressed air into the cultivation chamber via the inlet/outlet.

According to the arrangement, the carry-in opening and the inlet/outlet are provided together in one (1) place. This makes it possible to easily create a high pressure environment by providing, to a conventional closed facility, one (1) structure which can serve as both the carry-in opening and the inlet/outlet.

In order to attain the object, a plant cultivation method for carrying out cultivation by use of a plant cultivation device mentioned above, the method includes the steps of: placing a plant under a condition at a pressure which is higher than an atmospheric pressure; and cultivating the plant.

The method makes it possible to easily set a condition at a pressure which is higher than an atmospheric pressure. The method also allows further promotion of plant growth as compared to a plant cultivation method carried out at a normal pressure (approximately 1 atmosphere).

The plant cultivation method of the present invention is preferably arranged such that the plant is placed under a condition at a pressure of not less than 1.5 atmospheres and not more than 4 atmospheres.

According to the method, it is possible to further promote plant growth under such a condition than a condition at a normal atmospheric pressure.

As described earlier, the plant cultivation method in accordance with the present invention is a method for carrying out plant cultivation in a cultivation chamber for plant cultivation, the cultivation chamber being a sealed space in which a plant is placed, the method including the step of: cultivating the plant by causing a pressure device to increase an internal pressure of the cultivation chamber so that the internal pressure is higher than an atmospheric pressure.

The method allows further promotion of plant growth as compared to a plant cultivation method carried out at an atmospheric pressure (approximately 1 atmosphere).

### INDUSTRIAL APPLICABILITY

Plant cultivation in a high pressure environment is accomplished by use of a plant cultivation device of the present invention. Accordingly, the plant cultivation device of the present invention is applicable to a plant cultivation method of the present invention. The plant cultivation method of the present invention makes it possible to promote plant growth.

### REFERENCE SIGNS LIST

1 Plant cultivation device
10 Cultivation chamber
11 Inlet/outlet
12 Lighting apparatus
13 Temperature and humidity sensor
14 Nutrient solution supplying device
15 Temperature and humidity control device
16 Side wall (Wall)
20 Oil-free compressor (Compressor, Pressure device)
21 Pipe
30 Carry-in opening
31 Cover
32 Packing
34 Swivel (Second connecting member)
35 Protrusion (First connecting member)
61 Plant cultivation device
71 Inlet/outlet
72 Pipe

1. A plant cultivation method comprising the steps of:
placing a plant under a condition at a pressure of not less than 1.5 atmospheres and not more than 10 atmospheres; and
cultivating the plant.

2. The plant cultivation method as set forth in claim 1, wherein the plant is placed under a condition at a pressure of not less than 1.5 atmospheres and not more than 4 atmospheres.

3. A plant cultivation device comprising:
a cultivation chamber in which plant cultivation is carried out;
a compressor which supplies compressed air into the cultivation chamber;
a carry-in opening which is provided on a wall of the cultivation chamber and via which a material is carried in/out to/from the cultivation chamber; and
a cover which is provided to the carry-in opening and has a shape that protrudes toward an inside of the cultivation chamber,
the cover closing the carry-in opening by being in contact with a surface of the wall surrounding the carry-in opening, the surface being located on the cultivation chamber side, and
the cultivation chamber having an internal pressure higher than an atmospheric pressure by causing the compressor to supply compressed air into the cultivation chamber in a state in which the carry-in opening is closed.

4. The plant cultivation device as set forth in claim 3, wherein the shape of the cover is hemispherical.

5. The plant cultivation device as set forth in claim 3, further comprising:
a hinge which is provided to the surface of the wall of the cultivation chamber, the surface being located on the cultivation chamber side,
the cover being connected via the hinge to the wall of the cultivation chamber.

6. The plant cultivation device as set forth in claim 5, further comprising:
a first connecting member which is provided on an outer surface of the cover; and
a second connecting member which is provided on the wall of the cultivation chamber,
the first connecting member and the second connecting member engaging with each other in a state in which the carry-in opening is closed with the cover.

7. The plant cultivation device as set forth in claim 3, further comprising:
a packing which is provided between the cover and the wall of the cultivation chamber,
the carry-in opening being closed in a state in which the packing is sandwiched between the cover and the wall surrounding the carry-in opening.

8. The plant cultivation device as set forth in claim 3, further comprising:
an inlet/outlet which is provided to the cover,
the compressor supplying compressed air into the cultivation chamber via the inlet/outlet.

9. A plant cultivation method for carrying out cultivation by use of a plant cultivation device recited in claim 3,
said method comprising the steps of:
placing a plant under a condition at a pressure which is higher than an atmospheric pressure; and
cultivating the plant.

10. The plant cultivation method as set forth in claim 9, wherein the plant is placed under a condition at a pressure of not less than 1.5 atmospheres and not more than 4 atmospheres.

11. The plant cultivation method for carrying out plant cultivation in a cultivation chamber for plant cultivation, the cultivation chamber being a sealed space in which a plant is placed,
said method comprising the step of:
cultivating the plant by causing a pressure device to increase an internal pressure of the cultivation chamber so that the internal pressure is higher than an atmospheric pressure.

12. The plant cultivation device as set forth in claim 4, further comprising:
a hinge which is provided to the surface of the wall of the cultivation chamber, the surface being located on the cultivation chamber side,
the cover being connected via the hinge to the wall of the cultivation chamber.

13. The plant cultivation device as set forth in claim 4, further comprising:
a packing which is provided between the cover and the wall of the cultivation chamber,
the carry-in opening being closed in a state in which the packing is sandwiched between the cover and the wall surrounding the carry-in opening.

14. The plant cultivation device as set forth in claim 5, further comprising:
a packing which is provided between the cover and the wall of the cultivation chamber,
the carry-in opening being closed in a state in which the packing is sandwiched between the cover and the wall surrounding the carry-in opening.

15. The plant cultivation device as set forth in claim 6, further comprising:
a packing which is provided between the cover and the wall of the cultivation chamber,
the carry-in opening being closed in a state in which the packing is sandwiched between the cover and the wall surrounding the carry-in opening.

16. The plant cultivation device as set forth in claim 4, further comprising:
an inlet/outlet which is provided to the cover,
the compressor supplying compressed air into the cultivation chamber via the inlet/outlet.

17. The plant cultivation device as set forth in claim 5, further comprising:
an inlet/outlet which is provided to the cover,
the compressor supplying compressed air into the cultivation chamber via the inlet/outlet.

18. The plant cultivation device as set forth in claim 6, further comprising:
an inlet/outlet which is provided to the cover,
the compressor supplying compressed air into the cultivation chamber via the inlet/outlet.

19. The plant cultivation device as set forth in claim 7, further comprising:
an inlet/outlet which is provided to the cover,
the compressor supplying compressed air into the cultivation chamber via the inlet/outlet.

20. A plant cultivation method for carrying out cultivation by use of a plant cultivation device recited in claim 4,
said method comprising the steps of:
placing a plant under a condition at a pressure which is higher than an atmospheric pressure; and
cultivating the plant.
